(19) United States
(12) Patent Application Publication
(10) Pub. No.: US 2023/0408701 A1
(43) Pub. Date: Dec. 21, 2023

(54) SYSTEM AND METHOD FOR DETERMINING A POSITION OF A MOVABLE ARM OF A HIGH VOLTAGE DISCONNECTING SWITCH

(71) Applicant: Weinert Industries AG, Föritztal (DE)

(72) Inventors: Hakan Sayinc, Berlin (DE); Oliver Gross, Berlin (DE)

(73) Assignee: Weinert Industries AG, Föritztal (DE)

(21) Appl. No.: 18/035,494

(22) PCT Filed: Nov. 5, 2020
(86) PCT No.: PCT/EP2020/081058

§ 371 Date: May 4, 2023

(51) Int. Cl. G01S 17/894; H01H 11/00; G01S 17/58; G01S 7/481; G01S 7/4865

(52) U.S. Cl. CPC G01S 17/894; H01H 11/0062; G01S 17/58; G01S 7/4816; G01S 7/4865

(57) ABSTRACT

The present disclosure relates to a system for determining a position of a movable arm of a high voltage disconnecting switch. The system comprises a high voltage disconnecting switch with a movable arm for opening and closing the high voltage disconnecting switch and a time of flight sensor configured to determine a distance value indicating a distance between the time of flight sensor and the movable arm. The system further comprises a control device configured to determine, based on the distance value, whether the high voltage disconnecting switch is in an open state or in a closed state. Further, a method for determining a position of a movable arm of a high voltage disconnecting switch is provided.

The present disclosure is directed to a system and method for determining a position of a movable arm of a high voltage disconnecting switch.

Smart substation devices are paving the way for improving the operation safety and the reduction of downtimes. The digitization of the asset status with smart sensors allows a fast error localization and predictive maintenance. Breaking-closing disconnecting switches (BCDS) are among the most important components in today's substations. Breaking-closing disconnecting switches (BCDS) are also referred to herein as high voltage disconnecting switches. These components have moving parts. Therefore operating a BCDS naturally can have, e.g., the following failure modes:
The switch is mechanically blocked at a positon, which is neither “open” nor “closed”.
A relative position of male and female contact, which is not completely “closed” (low finger pressure) and which can lead to heat up of the contacts leading to a lower carried current.

The standard IEC 62271-102 states the general mandatory type tests for disconnecting switches. According to the IEC, it is expected that a device is indicating the position of the disconnecting switch correctly. Such a device is not specified in detail. According to Douillard et al., BCDS are causing a major part of significant events for the safety of the electrical system (ESS) in substations, see S. Douillard et al. “Disconnectors reliability on the French grid and means to reduce the consequences of their failures on the electrical system”, Cigre 2018. The main problem occurring is a loss of the “open or closed” information. Such events are restricting topology changes, weaken the substation system and require on-site intervention. These facts are motivating the development of smart sensors for monitoring the device status. By employing such sensors, data logging and processing enables to gain insights on the BCDS health state and if necessary, to start preventive actions.

Different methods are currently under investigation to enable a monitoring of the switch status. Douillard et al. are employing a real-time monitoring of the operating torque of the disconnector. With this method, the switch movement can be compared with minimum and maximum values. It was reported that the operating torque values are highly dependent on the temperature of the environment. This needs to be corrected by an algorithm.

A good review of further monitoring techniques is given by Bozhong et al. “Review on Breaking-closing Position Monitoring Method for Intelligent Disconnecting Switches”, IOP Conf. Ser.: Earth Environ. Sci. 223, 2018. A method under research is image recognition. In this method, the purpose is to extract features from image regions to derive the status of the BCDS, see, e.g., Wu et al., “An image recognition method of substation breakers state based on robot”, Power System Automation, Vol 36, 2020, and Chen et al., Image recognition in online monitoring of power equipment, Int. J. o. Adv. Rob. Syst. 2020. This can be done by fixed or traveling cameras for observing the switch. Besides advantages like high degree of automation and scaling, this method has disadvantages like the sensitivity to weather conditions and high cost. Also, using a camera for imaging makes the method sensitive to the magnetic fields in the environment of the BCDS.

Optics based approaches were presented by the authors Zhang et al., “Design and research on laser monitor device of intelligent high voltage disconnector position” Automation Application Vol 03, 2012, and Semedo et al., “Remote monitoring of High Voltage Disconnect Switches in Electrical Disctribution Substations”, Int. Symp. On Ind. Electr. ISIE, 2014. Zhang et al. used a laser source and a reflection mirror to prove if the switch contact is in the right position. Semedo et al. integrated three subsystems to a single monitoring unit. The relative positon sensing is conducted by employing a single LED and 32 phototransistors. MEMS were employed to enable vibration measurements during operation. As current source, a solar panel was used. The operation duration of the monitoring unit was depending on the data communication frequency. The presented methods, however, have room for improvement with regard to spatial and/or temporal resolution for measurements that enable predictive maintenance. Furthermore, all of the employed subsystems in the approach of Semedo et al. necessarily need a current flow. In the direct vicinity of high magnetic fields, it is unclear how the accurate calibration and stable operation of the electrically driven subsystems can be secured.

It is desired to achieve grid stability for tackling future challenges like including renewable energy sources to the power grid despite their unplannable production patterns and supporting upcoming energy consumption peaks due to coupling of the electro mobility to the power grid. A digitization of substations by smart sensors is therefore desired.

These sensor should be compatible with the high electric and magnetic fields in substations. Optical technology enables operation of such sensors based on optical principles, while avoiding interference between electric and magnetic fields of the environment. However, e.g., a camera evaluation only works with a clear view of the movable arm(s) of the switch and can be interfered, e.g., by fog, rain, or snow.

In view of the above, it is an object of the present disclosure to provide a system and a method for determining a position of a movable arm of a high voltage disconnecting switch, which overcomes at least one of the above problems of the prior art and/or other related problems.

According to a first aspect, a system for determining a position of a movable arm of a high voltage disconnecting switch is provided. The system comprises a high voltage disconnecting switch with a movable arm for opening and closing the high voltage disconnecting switch and a time of flight sensor configured to determine a distance value indicating a distance between the time of flight sensor and the movable arm. The system further comprises a control device configured to determine, based on the distance value, whether the high voltage disconnecting switch is in an open state or in a closed state.

In the following description, the expression “arm” refers to the “movable arm”, the expression “switch” refers to the “high voltage disconnecting switch”, and the expression “sensor” refers to the “time of flight sensor”, unless indicated otherwise.

The movable arm may be a metallic arm configured to open or close an electric connection. In the open state, electric current cannot flow through the movable arm and, therefore, through the switch. In the closed state, electric current can flow through the movable arm and, therefore, through the switch. Between the open state and the closed state, intermediate states may exist, that the movable arm passes while being moved from the open state to the closed state and vice versa. In these intermediate states, a secure connection/disconnection cannot be guaranteed.

The movable arm may carry out a rotational movement. The rotational movement is such that the movable arm moves within a plane (in the following: the plane of the rotational movement). In particular, a rotational axis of said movement may be arranged such that it passes through a first end of the movable arm. In this case, the movement of the movable arm may be regarded as a swivel movement. On a second end of the movable arm, a first contact portion may be arranged that is configured to be brought in electric contact with a second contact portion of the switch to thereby close the switch. In the closed state, electric current may flow from the first end of the arm, through the arm, through the contact portion of the arm, to the second contact portion (or in the reverse direction). In the open state, no current can flow because the first contact portion and the second contact portion are physically separated (by air).

The second contact portion of the switch may be either fixed or it may be arranged at an end of a further movable arm of the switch. In the latter case, the switch may comprise two movable arms that move towards each other when the switch closes and that move away from each other when the switch opens. Both arms may move in a rotational movement. Both rotational movements may occur in the same plane. The first contact portion and the second contact portion may be configured as male contact portion and female contact portion, wherein, in the closed state, the female contact portion embraces the male contact portion.

The movement of the movable arm may be operated by an electrically driven actuator (e.g., an electric motor) under the control of a control device (e.g., the control device described herein). The system may be integrated or may be configured to be integrated into an electrical substation.

In the present disclosure, according to the common definition, high voltage may be defined as >1 kV for AC RMS voltage and >1.5 kV for DC voltage.

The distance value may be any value indicative of the distance between the time of flight sensor and the movable arm. For example, the distance value may directly indicate a distance (e.g., in m or mm) or it may be a time value indicative of a runtime of a laser signal between the time of flight sensor and the movable arm and back (e.g., in s or ns). Further, a time-dependent distance value may be provided by the time of flight sensor and recorded by the control device (e.g., in a memory of the control device). The time of flight sensor may be operated in a pulsed mode, wherein, for each pulse a corresponding distance value is generated. The distance value may be a distance value of one particular pixel of an image sensor of the time of flight sensor or it may be an average value of a predefined subset of the pixels. In case a pixelated image sensor is used in the time of flight sensor, each one of the pixels of the detector has a predefined direction of detection (and a corresponding detection area) within the overall field of view provided by the time of flight sensor. The distance value for the respective pixel is indicative of a distance along said direction of detection.

The control device may comprise at least one processor and at least one memory. In the memory, instructions may be stored that cause the processor to operate according to one or more of the methods described herein. The control device may include components that are embodied in hardware and/or in software. One or more components of the control device may be physically separated from each other. For example, one or more components of the control device may be located in a cloud.

The control device is configured to determine, based on the distance value, whether the high voltage disconnecting switch is in an open state or in a closed state. For example, the memory of the control device may contain instructions that cause the processor to determine, based on the distance value, whether the high voltage disconnecting switch is in an open state or in a closed state. In this context, the control device may also be regarded as comprising a “determinator” or “determining unit” that carries out the task of determining.

Further, the control device may be configured to determine a position of the movable arm. In other words, it may also be possible to determine intermediate states of the movable arm, between the open state and the closed state. For example, it may be possible to determine an opening angle of the movable arm (e.g., 0° may indicated the closed state and 90° may indicate the opened state).

The movable arm may be configured to rotationally move within a plane of the rotational movement and the time of flight sensor may be arranged outside the plane and directed towards the plane, such that at least a part of the movable arm is within a field of view of the time of flight sensor during at least a part of a movement of the movable arm from the closed state to the open state.

For example, the at least a part of the movable arm may be within the field of view of the sensor in the closed state or in the open state or in both the open state and the closed state. The sensor may be arranged on a ground and it may be directed upwards towards the plane of movement of the movable arm. The field of view may be defined as an area, in which the sensor can measure distances. For example, in case the sensor comprises a two-dimensional pixelated image sensor, the field of view may be defined as an area in which the image sensor may measure distances (by detecting a reflected laser pulse).

For example, the sensor may be arranged such that, in the closed state, at least a part of the movable arm is within the field of view of the sensor. The sensor may be arranged such that, in the closed state, the determined distance value corresponds to a predefined distance and, in the open state, the determined distance value corresponds to a distance larger than the predefined distance. For example, the control device may be configured such that it determines that the high voltage disconnecting switch is in the closed state when the determined distance value is equal or smaller than a predefined distance value and that the high voltage disconnecting switch is in the open state when the determined distance value is larger than the predefined value, by at least a predefined amount. For example, the predefined distance value may be 2 m and the control device may determine the open state when the sensor measures a distance value of at least 3 m (=2 m+1 m). The open state may also be determined when no distance can be measured by the sensor, i.e., when the determined distance is at a maximum value predefined by the sensor (e.g. predetermined by a pulse length of a used laser pulse).

In the arrangement where the sensor is directed towards the plane, more than one pixel of the sensor may be evaluated. In this case, it may be determined by the control device that the switch is in the closed state, when a predefined subset of pixels output a distance value equal or smaller than a predefined distance value. Further, it may be determined by the control device that the switch is in a safe position when a different subset of pixels output a distance value equal or smaller than the predefined distance value. Further, it may be determined by the control device that the switch is in the open position when none of the pixels outputs a distance value equal or smaller than the predefined distance value.

In some situations, the above arrangement may be advantageous since it may allow an easy placement of the sensor (e.g. on the ground) and since it may provide a clearly detectable change in the distance signal when the arm moves out of a detection region of a particular pixel of the sensor. In other words, the gradient of the determined time-dependent distance value is high, such that a point in time the movable arm passes the detection region of a particular pixel may be precisely determined.

The movable arm may be configured to rotationally move within a plane of the rotational movement and the time of flight sensor may be arranged within the plane and directed towards the movable arm, such that at least a part of the movable arm is within a field of view of the time of flight sensor in the closed state.

In this case, a viewing direction of the sensor may be within the plane of the rotational movement. The viewing direction of the sensor may correspond to an optical axis of the sensor. The viewing direction may be directed towards the movable arm of the switch. At least in the closed state, the movable arm may intersect the viewing direction of the sensor.

The control device may be configured such that it determines that the high voltage disconnecting switch is in the closed state when the determined distance value is smaller than a first predefined value and that the high voltage disconnecting switch is in the open state when the determined distance value is larger than a second predefined value. Further, the control device may be configured to output an error when the determined distance value is between the first predefined value and the second predefined value for longer than a predefined time. Generally speaking, and for all embodiments described herein, the control device may be configured to output an error when the switch is determined to be neither in the open state nor in the closed state for longer than a predetermined time.

In some situations, the above arrangement may be advantageous since it may allow a tracking of the movable arm over a long distance, such that a position of the movable arm may be determined in a plurality of states (i.e., in the closed state and in intermediate states).

The time of flight sensor may be arranged such that the movable arm is within the field of view of the time of flight sensor both in the open state and in the closed state.

In this case, the sensor can detect a distance to the movable arm both in the closed state and in the open state. The control device may be configured such that it determines that the high voltage disconnecting switch is in the closed state when the determined distance value is within a predefined first range and that the high voltage disconnecting switch is in the open state when the determined distance value is within a predefined second range.

In some situations, the above arrangement may be advantageous since it may allow a tracking of the movable arm over a long distance, such that a position of the movable arm may be determined in the open state, the closed state, and intermediate states.

The control device may be configured to determine a velocity of the movable arm, based on the distance value.

The velocity may be determined based on a gradient of the time-dependent distance value. Further, when the sensor comprise a two-dimensional pixelated image sensor, a plurality of distance values of a plurality of pixels may be considered. In this case, the velocity may be determined based on a difference of the distance values of the respective pixels. For example, the velocity may be determined based on a time difference between two events, wherein a first event corresponds to the movable arm leaving a detection region of a first pixel of the sensor and a second event corresponds to the movable arm leaving a detection region of a second pixel of the sensor.

The velocity may be used to determine whether the movable arm moves in a normal mode or whether an error exists. In case it is determined that the velocity is outside a predefined range, an error signal may be output by the control device.

The time of flight sensor may comprise an image sensor with a plurality of pixels, the image sensor being configured to output a distance value for each one of the plurality of pixels and the control device may be configured to determine whether the high voltage disconnecting switch is in the open state or in the closed state based on the plurality of distance values for the plurality of pixels.

For example, the output of the plurality of pixels may be used to improve the reliability of the distance value. For this case, the distance value may be determined as an average value of individual distance values of the individual pixels. However, the individual distance values of the pixels may also be considered independently.

For example, the plurality of pixels may be used to more accurately determine a position of the movable arm. Each pixel may have its own detection region within an overall field of view of the sensor. In other words, each pixel may output a distance value in a particular predefined detection region of the pixel. When the sensor is arranged such that the arm moves through the detection area, the individual distance values may be considered to determine, in which part of the detection area the movable arm currently is located. For example, the movable arm may be located in detection areas, for which the distance value is equal or smaller than a predefined threshold and in detection areas, for which the distance is above the predefined threshold value, it is determined that the movable arm is currently not located in these areas.

The time of flight sensor may comprise an image sensor with a plurality of pixels, the image sensor being configured to output a distance value for each one of the plurality of pixels and the control device may be configured to determine the velocity of the movable arm based on the plurality of distance values for the plurality of pixels.

The distance may be detected, for example, when a time is considered between a first event detected by a first pixel and a second event detected by a second pixel. The two events may be changes in the measured distance values. The two events may be changes in the measured distance values with a gradient larger than a predefined value. In this case, the detection areas may be determined, which the movable arm has just left or entered.

The control device may be further configured to switch on at least one additional sensor in response to the time of flight sensor detecting a change in the distance value.

The additional sensor may be another sensor located in the vicinity of the switch. The additional sensor may be configured to measure one or more physical properties and/or values in the context with a switching process of the switch. The additional sensor may comprise at least one of a camera, a light sensor, a temperature sensor, a vibration sensor, an acceleration sensor, a magnetic field sensor, or an acoustic sensor. Further, more than one sensor of the aforementioned list may be provided and switched on by the control device. The additional sensor may be switched on such that it starts recording data. In this way, it may be ensured that no energy is wasted in times no switching process is carried out. In other words, the additional sensor only starts collecting data and consuming energy when a switching process is detected.

The control device may be further configured to switch off at least one additional sensor in response to the time of flight sensor detecting no change in the distance value for at least a predetermined time.

The at least one additional sensor may be the sensor that has been switched on in response to the time of flight sensor detecting the change in the distance value. The predetermined time may be, e.g., one day (i.e., 24 h). After the predetermined time has passed and no change in the distance value has been detected, the additional sensor may be switched off, such that it enters a sleep mode. In this mode, no or only a reduced amount of energy is consumed. No or only a reduced amount of data is recorded by the additional sensor in the sleep mode. In this way, it can be ensured that no energy is wasted in times no switching process is carried out. In other words, the additional sensor stops collecting data and consuming energy after a predetermined time after the last switching process has passed.

According to a second aspect, a method for determining a position of a movable arm of a high voltage disconnecting switch is provided. The method comprises moving a movable arm of a high voltage disconnecting switch for opening or closing the high voltage disconnecting switch and determining, with a time of flight sensor, a distance value indicating a distance between the time of flight sensor and the movable arm. The method further comprises determining, based on the distance value, whether the high voltage disconnecting switch is in an open state or in a closed state.

Each of the details and advantageous embodiments of the first aspect discussed above may apply to the method of the second aspect.

The movable arm may rotationally move within a plane of the rotational movement and the time of flight sensor may be arranged outside the plane and directed towards the plane, such that at least a part of the movable arm is within a field of view of the time of flight sensor during at least a part of a movement of the movable arm from the closed state to the open state.

The movable arm may rotationally move within a plane of the rotational movement and the time of flight sensor may be arranged within the plane and directed towards the movable arm, such that at least a part of the movable arm is within a field of view of the time of flight sensor in the closed state.

The time of flight sensor may be arranged such that the movable arm is within the field of view of the time of flight sensor both in the open state and in the closed state.

The method may further comprise determining a velocity of the movable arm, based on the distance value.

The time of flight sensor may comprise an image sensor with a plurality of pixels, the image sensor outputting a distance value for each one of the plurality of pixels and the method may further comprise determining whether the high voltage disconnecting switch is in the open state or in the closed state based on the plurality of distance values for the plurality of pixels.

The time of flight sensor may comprise an image sensor with a plurality of pixels, the image sensor outputting a distance value for each one of the plurality of pixels and the method may further comprise determining the velocity of the movable arm based on the plurality of distance values for the plurality of pixels.

The method may further comprise switching on at least one additional sensor in response to the time of flight sensor detecting a change in the distance value.

The method may further comprise switching off at least one additional sensor in response to the time of flight sensor detecting no change in the distance value for at least a predetermined time.

The present disclosure shall be further explained with reference to the enclosed figures. These figures schematically show:

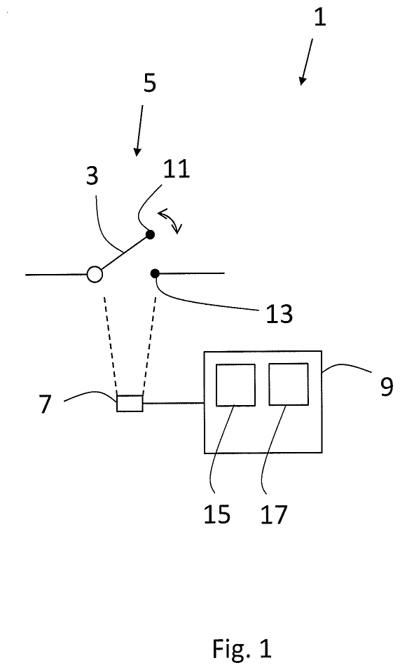

FIG. 1 a schematic representation of a system for determining a position of a movable arm of a high voltage disconnecting switch according to the present disclosure;

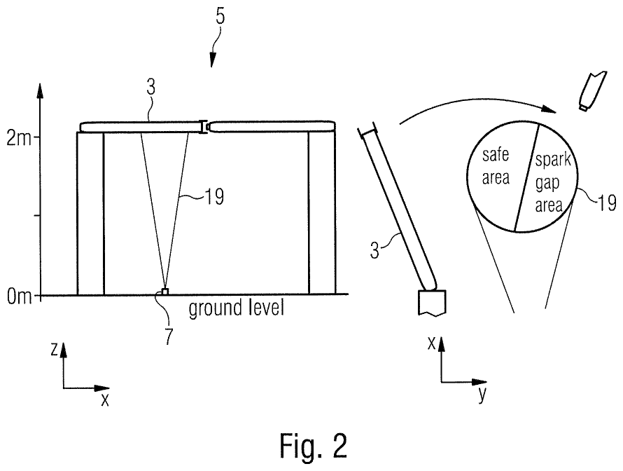

FIG. 2 an arrangement of the movable arm and the time of flight sensor according to a first embodiment;

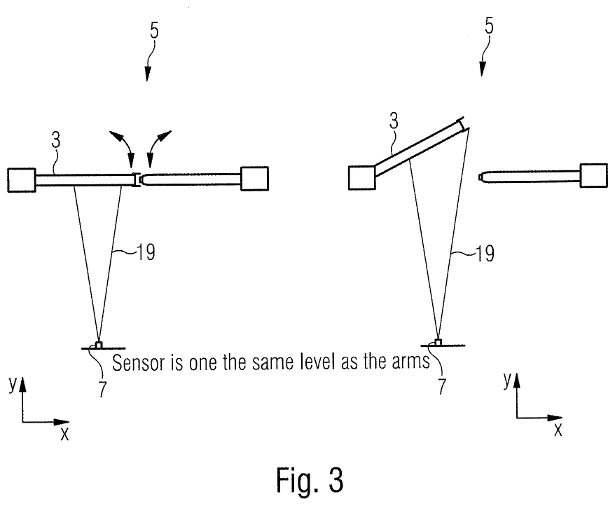

FIG. 3 an arrangement of the movable arm and the time of flight sensor according to a second embodiment;

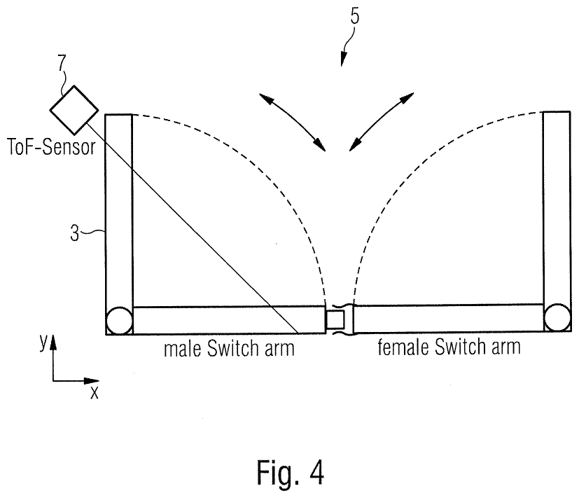

FIG. 4 an arrangement of the movable arm and the time of flight sensor according to a third embodiment;

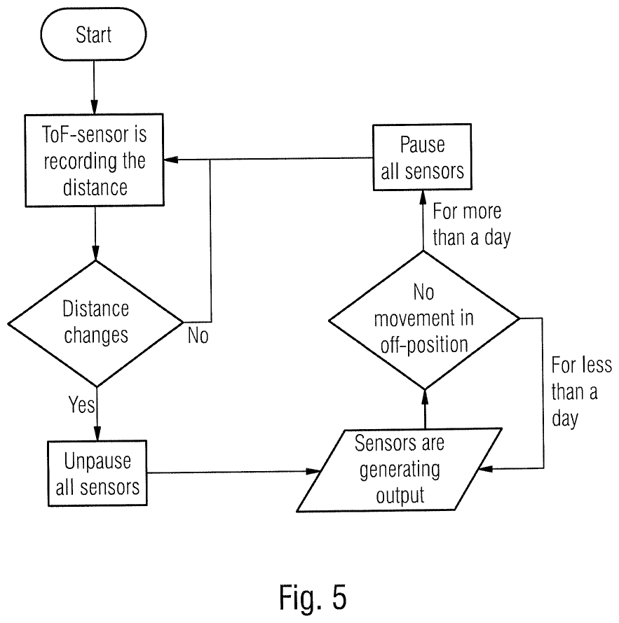

FIG. 5 a flow diagram of a method for controlling at least one additional sensor;

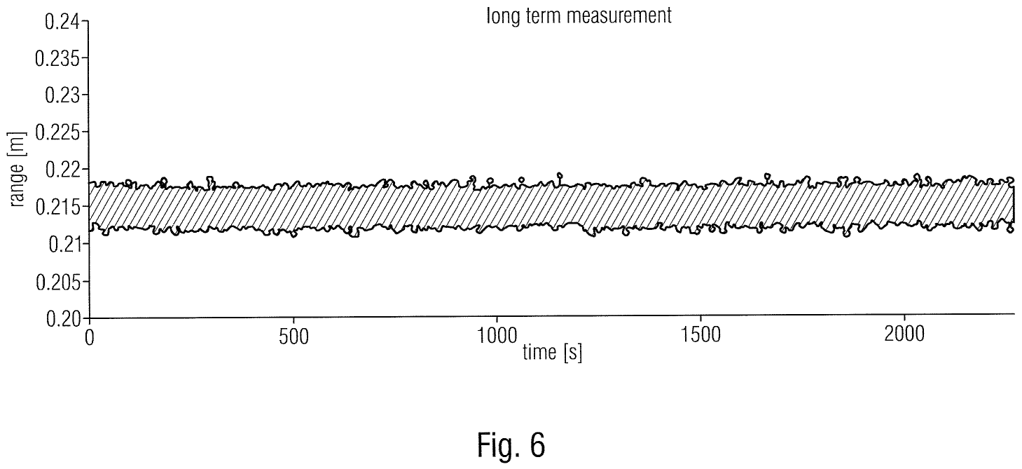

FIG. 6 a long term measurement of a distance value for determining the stability of the sensor;

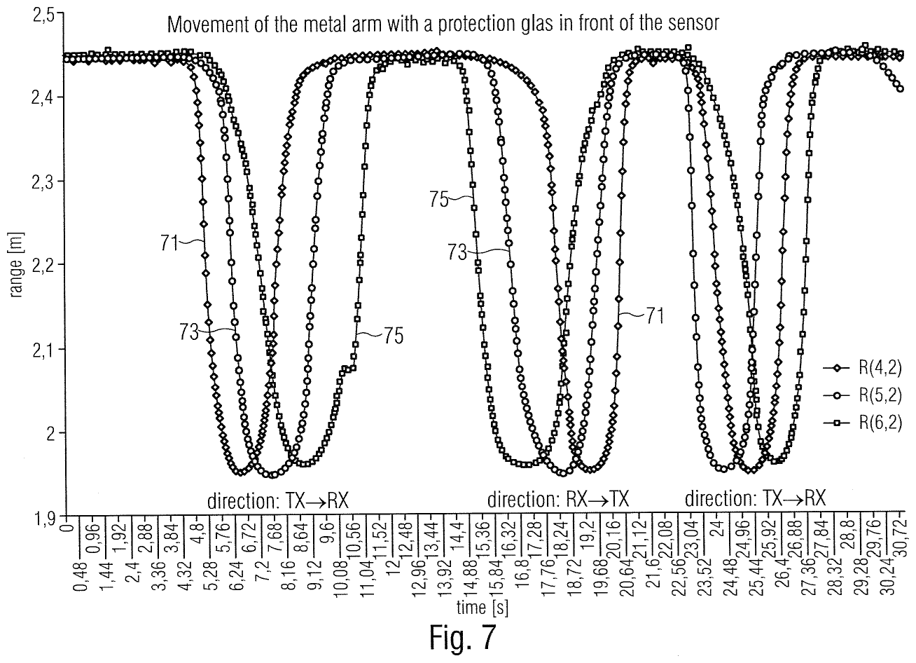

FIG. 7 an exemplary measurement of a movement of the movable arm according to the first embodiment; and

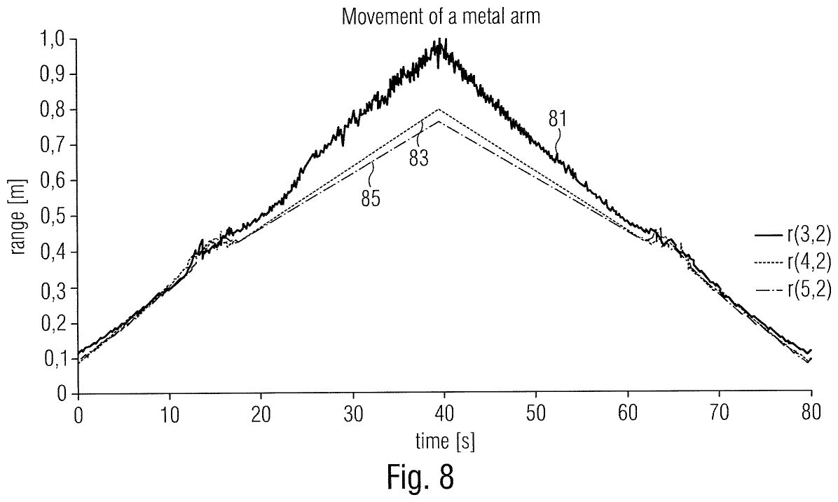

FIG. 8 an exemplary measurement of a movement of the movable arm according to the third embodiment.

In the following, without restriction, specific details will be provided, for providing a complete understanding of the present disclosure. It shall be appreciated by the person skilled in the art that the present disclosure can be embodied in other embodiments that may differ from the details provided below. For example, in the following, specific configurations of a high voltage disconnecting switch will be described and shown in the figures, which are not to be understood as limiting. Different embodiments and configurations, e.g., of the switch, are possible.

A core idea of the present disclosure is the use of a time of flight (ToF) sensor for determining an operational state (open state or closed state) of a high voltage disconnecting switch.

The time of flight technique lead to the development of time of flight sensors with a single pixel or with multiple pixels. In the latter case, the sensor may also be referred to as time of flight camera since a 3-dimenional image (or depth image) may be recorded. Although the present disclosure is described in the context of time of flight sensors having a two-dimensional pixelated image sensor (i.e., sensors with multiple pixels), the present disclosure shall not be limited to such devices and also a one pixel sensor may be used, which is only able to record one distance value at a given time (i.e., only one time-dependent distance value).

Commercially available devices are allowing free programming of multi pixel ToF circuits to measure distances and angles.

The sensors of the present disclosure are based on the time of flight (ToF) principle, which is the measurement of the time t taken by a laser pulse to travel a distance through a medium (e.g., air). Depending on the distance of an object, each pixel on the image sensor receives the reflected/scattered pulse with a delay. A microcontroller to evaluate a velocity, a path length D or a surface property uses the information.

t=2*D/c,

wherein c is the speed of light in the medium.

The pulse duration T defines the maximum measurable distance Dmax:

Dmax=c*T/2

A ToF sensor may comprise an image sensor with multiple pixels, a laser diode and a micro controller. The laser and the image sensor are optimized at 850 nm wavelength to minimize an impact from the environment.

Depending on the divergence a of an optical system of the sensor (comprising, e.g., a lens), the sensor can cover an area A (field of view) of:

A=π*tan²(α)*D²,

wherein D is the distance.

A general schematic representation of a system 1 for determining a position of a movable arm 3 of a high voltage disconnecting switch 5 is shown in FIG. 1. The system 1 comprises the high voltage disconnecting switch 5 with the movable arm 3 for opening and closing the high voltage disconnecting switch 5 and a time of flight sensor 7 configured to determine a distance value indicating a distance between the time of flight sensor 7 and the movable arm 3. The system 1 further comprises a control device 9 configured to determine, based on the distance value, whether the high voltage disconnecting switch 5 is in an open state or in a closed state.

The system 1 is integrated in an electrical substation, wherein the switch 5 provides a disconnecting switch function for the substation, according to known principles. Further, the switch 5 may be operated by an electric actuator (such as an electric motor) under the control of a control device of the electrical substation. For example, the control device for the switch 5 may be the same as the control device 9 for the sensor 7.

As schematically shown in FIG. 1, the arm 3 carries out a swivel movement (or “rotational movement”) when the switch 5 is opened or closed. During this swivel movement, the arm 3 moves within a plane (in the following: plane of rotational movement).

In a closed state of the switch 5, a first contact portion 11 provided at one end of the arm 3 is in physical and electrical contact with a second contact portion 13 of the switch, such that current can flow through the switch 5. In an open state of the switch 5, the two contact portions 11, 13 are physically separated from each other by air and no current can flow. For the following considerations, it is of subordinate relevance whether the second contact portion 13 is provided fixed or whether it is itself provided at an end portion of a second movable arm of the switch 5. The following details are applicable to both situations.

The sensor 7 is positioned such that a distance value measured by the sensor 7 changes when the switch 5 changes its state from the closed state to the open state and vice versa. For this purpose, at least a part of the arm 3 is within a field of view of the sensor 7, at least for part of the movement from the closed state to the open state.

The control device 9 comprises a processor 15 and a memory 17. In the memory 17, instructions are stored that cause the processor 15 to carry out at least one of the methods described herein. In particular, the control device 9 is configured to determine, based on signals received by the sensor 7, whether the switch 5 is in the open state or in the closed state. At least a part of the control device 9 may be located physically separated from the sensor 7 (e.g., outside the electrical substation) and, e.g., within a server or a cloud. The following figures focus on the structural arrangement of the switch 5 with regard to the sensor 7, wherein the control device 9 is not shown, although it is part of the system 1.

FIG. 2 shows a first embodiment of an arrangement of the sensor 7 with regard to the movable arm 3. The sensor 7 comprises a microcontroller, a mount, a laser diode, an image sensor, and optics. One method for clearance detection is to place the sensor 7 beneath the movable arm 3, as shown in FIG. 2.

In the embodiment of FIG. 2, the movable arm 3 is configured to rotationally move within a plane of the rotational movement and the time of flight sensor 7 is arranged outside the plane. In the Cartesian coordinate system defined with regard to FIG. 2, the plane of the rotational movement is parallel to a x-y-plane. The left part of FIG. 2 shows a side view of the system and the right part of FIG. 2 shows a top view of the same system. As shown in FIG. 2, as an example, the arm 3 (and, thus, the plane of the rotational movement) is arranged 2 m above ground level.

The sensor 7 is directed towards the plane, such that at least a part of the movable arm 3 is within a field of view 19 of the time of flight sensor 7 during at least a part of a movement of the movable arm 3 from the closed state to the open state.

The left part of FIG. 2 shows the switch 5 in the closed state and the right part of FIG. 2 shows the switch in an open state.

As shown in FIG. 2, the arm 3 carries out a swivel movement in order to bring the switch from the closed state to the open state and vice versa. In the example shown in FIG. 2, the field of view 19 of the sensor 7 is positioned such that, in the closed state (see left part of FIG. 2), a part of the arm 3 is within the field of view 19.

In the present embodiment, but also in the other embodiments discussed herein, the sensor 7 may permanently output laser pulses and, therefore, may permanently record distance values that are evaluated by the control device 9. The control device 9 therefore records a time-dependent distance value. In case a plurality of pixels are considered, the control device 9 records a time-dependent distance value for each pixel.

The control device may therefore determine whether the switch 5 is in the closed state or the open state, as follows.

In a one-pixel embodiment: When the detected distance value is below a predefined threshold, the control device 9 determines that the switch 5 is in the closed state. At all other times, the control device 9 determines that the switch 5 is in the open state.

In a multi-pixel embodiment: As shown in the right part of FIG. 2, different sub-areas may be defined in the field of view of the sensor 7, such that each sub-area represents a particular state of the switch 5. The sub-areas correspond to one or more detection areas of one or more pixels of the sensor 7. When a pixel of the respective sub-area detects a distance value below a predefined threshold value, the control device 9 determines that the arm 3 is located in this sub-area. Hence, it can be determined, e.g., whether the arm 3 of the switch 5 is in the closed state, a spark gap area, a safe area, or in the open state. Thereby, between the open state and the closed state, intermediate states may be defined.

FIG. 3 shows a second embodiment, wherein the sensor 7 is positioned on the same level as the movable arm 3. In other words, the time of flight sensor 7 is arranged within the plane of the rotational movement. The switch 5 and its arm 3 may be the same as the one described with regard to FIG. 2. However, the sensor 7 is positioned 2 m above the ground level, in the plane of the rotational movement of the arm 3. The sensor is directed towards the movable arm 3, such that at least a part of the movable arm 3 is within the field of view 19 of the time of flight sensor 7 in the closed state. In the embodiment of FIG. 3, the viewing direction of the sensor 7 is perpendicular to the arm 3 in the closed state.

Both the left part and the right part of FIG. 3 are top views of the system 1 (i.e., along a z-direction). The left part of FIG. 3 shows the switch 5 in its closed state and the right part of FIG. 3 shows the switch 5 in an intermediate state. In the open state, the arm 3 would be oriented along the y-direction.

As shown in FIG. 3, the sensor 7 may monitor the distance to the arm 3 both in the closed state and when the arm 3 leaves the closed state towards the open state.

The control device 9 may therefore determine whether the switch 5 is in the closed state or the open state, as follows.

In a one-pixel embodiment: When the detected distance value is below a predefined threshold, the control device 9 determines that the switch 5 is in the closed state.

When the distance value is above the predefined threshold, the switch is determined to be in an intermediate state and when the distance value is above a second predefined threshold value, the control device 9 determines that the switch 5 is in the open position.

In a multi-pixel embodiment: More pixels may be evaluated to increase the reliability of the method.

FIG. 4 shows a third embodiment similar to the second embodiment, wherein the sensor 7 is arranged in the plane of the rotational movement of the arm 3. FIG. 4 shows a top view along the z-axis. A difference of the arrangement of FIG. 4 with regard to FIG. 3 is that a viewing direction of the sensor 7 is 45° with regard to the arm 3 in the closed state. In this arrangement, it is ensured that the arm 3 is in the field of view of the sensor 7 both in the open state and in the closed state (both states are shown in FIG. 4).

The control device 9 may therefore determine that the switch 5 is in the closed state, when the measured distance is within a predefined range and that the switch 5 is in the open state, when the measured distance is within a different predefined range. Values in between the ranges may be assigned to intermediate states of the switch 5.

The switch arms 3 are not in operation all the time and therefore there would be many unnecessary data be generated. A ToF sensor 7 can be used in a standby mode, where it only acquires data when there has been movement within a certain time. This can also be used to trigger other sensors.

FIG. 5 shows a flow diagram of a possible interaction with other sensors. When the algorithm starts, no sensor is generating an output unless the ToF sensor 7 records a movement of the switch arm 3. With the first movement of the switch arm 3 all the connected sensors are started/unpaused until the arm did not move for more than a predefined time in the off position. If so, all sensors will be paused again. As indicated in FIG. 5, the predefined time may be one day (24 h), but it is not limited to that.

The above method may be regarded as a master/slave behavior. The time of flight sensor 7 is a master sensor, which triggers an on/off state of other sensors of the electrical substation. When the distance value measured by the sensor 7 does change, all of the other sensors (slave sensors) are switched on, such that they record data and generate output. When the distance value measured by the sensor 7 does not change for longer than a predetermined time, the other sensors may be switched off again. This may help to save energy, since the operation of the other sensors may be energy consuming. One example of another sensor is a camera, which may start acquiring images when it is switched on. The operation of FIG. 5 may be controlled by the control device 9. The data of the other sensors 9 may be transmitted to the control device 9.

The stability of the time of flight measurements is shown in FIG. 6 for a long term measurement. The measurement has been performed on a metal arm 3 of a high voltage disconnecting switch 5 with about 60,000 measurement points. The sensor 7 has been measuring for 40 minutes at a constant distance. From the measured data, a standard deviation of 0.0015 m can be derived. This equals a percentage of 0.68%. The measurement of FIG. 6 shows that available time of flight sensors are sufficiently stable for the purpose described in the present disclosure.

FIG. 7 shows a measurement of a sensor 7 that was conducted in the configuration as shown in FIG. 2. For this measurement, a time of flight sensor 7 was placed 2 m below a movable metal arm 3. While the ToF sensor 7 was measuring, the arm 3 moved from the left side (here called TX) to the right side (here called RX). In FIG. 7 the signals (i.e., time-dependent distance values) of three different pixels is plotted, namely r(4, 2) 71, r(5, 2) 73, and r(6, 2) 75. Those pixels are positioned next to each other on the sensor 7. Depending on from which side the arm 3 is moving, either pixel r(4, 2) or r(6, 2) is giving a signal first. In FIG. 7, a movement from left to right (TX to RX) and from right to left (RX to TX) can be observed. Based on a delay between the signals of r(4, 2) and r(6, 2), the velocity of the arm 3 can be calculated by the control device 9.

FIG. 8 shows a measurement of a sensor 7 that was conducted in the configuration as shown in FIG. 4. For this measurement, the sensor 7 was placed on the same level of the metal arm 3 and the distance towards the arm 3 was measured versus time. Similar to FIG. 7, also FIG. 8 shows the curves of three different adjacent pixels of the sensor 7, namely r(3, 2) 81, r(4, 2) 83, and r(5, 2) 85.

During the first 40 seconds, the arm 3 has been moving away from the sensor 7 and after that, it moved back towards the sensor 7. The three lines 81, 83, 85 represent different pixels, wherein each pixel detects a slightly different part of the arm 3 than the other pixels, since the detection areas of the pixels differ from each other.

Based on the curves of FIG. 8, a position of the arm 3 can be reliably determined. Further, a velocity may be determined based on a gradient of one of the curves.

In one or more embodiments of the present disclosure, as soon as the sensor 7 detects a movement of the arm 3, the sensor 7 starts its algorithm. The microcontroller of the sensor 7 then saves the status request and the distance measurement of a certain amount of pixels in a temporary cache. Further, the distance measurement may be directly saved in the memory of the control device 9.

The distance is translated into the position of the arm 3 in the system 1 and, optionally, its velocity. At defined positions, the control device 9 can start other sensors/algorithms. The data may be depicted on a screen, a display on the sensor 7 or on the control device 9, or it is saved in a file (e.g., a .txt file) on the control device 9 and/or in a cloud.

An additional lens can be used to increase or decrease the divergence of the sensor 7. The sensor 7 can also be coupled to optical fibers. That way, the distance between the electrical sensor module and the electromagnetic field of the switch 5 can be increased.

Embodiments described herein provide a reliable technique for determining a state (open state or closed state) of a high voltage disconnecting switch.

1. A system (1) for determining a position of a movable arm (3) of a high voltage disconnecting switch (5), the system (1) comprising:
a high voltage disconnecting switch (5) with a movable arm (3) for opening and closing the high voltage disconnecting switch (5);
a time of flight sensor (7) configured to determine a distance value indicating a distance between the time of flight sensor (7) and the movable arm (3); and
a control device (9) configured to determine, based on the distance value, whether the high voltage disconnecting switch (5) is in an open state or in a closed state.

2. The system (1) of claim 1, wherein the movable arm (3) is configured to rotationally move within a plane of the rotational movement and wherein the time of flight sensor (7) is arranged outside the plane and directed towards the plane, such that at least a part of the movable arm (3) is within a field of view of the time of flight sensor (7) during at least a part of a movement of the movable arm (3) from the closed state to the open state.

3. The system (1) of claim 1, wherein the movable arm (3) is configured to rotationally move within a plane of the rotational movement and wherein the time of flight sensor (7) is arranged within the plane and directed towards the movable arm (3), such that at least a part of the movable arm (3) is within a field of view of the time of flight sensor (7) in the closed state.

4. The system (1) of claim 3, wherein the time of flight sensor (7) is arranged such that the movable arm (3) is within the field of view of the time of flight sensor (7) both in the open state and in the closed state.

5. The system (1) of any one of claims 1 to 4, wherein the control device (9) is configured to determine a velocity of the movable arm (3), based on the distance value.

6. The system (1) of any one of claims 1 to 5, wherein the time of flight sensor (7) comprises an image sensor with a plurality of pixels, the image sensor being configured to output a distance value for each one of the plurality of pixels, wherein the control device (9) is configured to determine whether the high voltage disconnecting switch (5) is in the open state or in the closed state based on the plurality of distance values for the plurality of pixels.

7. The system (1) of claim 5, wherein the time of flight sensor (7) comprises an image sensor with a plurality of pixels, the image sensor being configured to output a distance value for each one of the plurality of pixels, wherein the control device (9) is configured to determine the velocity of the movable arm (3) based on the plurality of distance values for the plurality of pixels.

8. The system (1) of any one of claims 1 to 7, wherein the control device (9) is further configured to switch on at least one additional sensor in response to the time of flight sensor (7) detecting a change in the distance value.

9. The system (1) of any one of claims 1 to 8, wherein the control device (9) is further configured to switch off at least one additional sensor in response to the time of flight sensor (7) detecting no change in the distance value for at least a predetermined time.

10. A method for determining a position of a movable arm (3) of a high voltage disconnecting switch (5), the method comprising:
moving a movable arm (3) of a high voltage disconnecting switch (5) for opening or closing the high voltage disconnecting switch (5);
determining, with a time of flight sensor (7), a distance value indicating a distance between the time of flight sensor (7) and the movable arm (3); and
determining, based on the distance value, whether the high voltage disconnecting switch (7) is in an open state or in a closed state.

11. The method of claim 10, further comprising:
determining a velocity of the movable arm (3), based on the distance value.

12. The method of claim 10 or 11, wherein the time of flight sensor (7) comprises an image sensor with a plurality of pixels, the image sensor outputting a distance value for each one of the plurality of pixels, wherein the method further comprises:
determining whether the high voltage disconnecting switch (5) is in the open state or in the closed state based on the plurality of distance values for the plurality of pixels.

13. The method of claim 11, wherein the time of flight sensor (7) comprises an image sensor with a plurality of pixels, the image sensor outputting a distance value for each one of the plurality of pixels, wherein the method further comprises:
determining the velocity of the movable arm (3) based on the plurality of distance values for the plurality of pixels.

14. The method of any one of claims 10 to 13, further comprising:
switching on at least one additional sensor in response to the time of flight sensor (7) detecting a change in the distance value.

15. The method of any one of claims 10 to 14, further comprising:
switching off at least one additional sensor in response to the time of flight sensor (7) detecting no change in the distance value for at least a predetermined time.
